(19) United States
(12) Patent Application Publication
(10) Pub. No.: US 2007/0175726 A1
(43) Pub. Date: Aug. 2, 2007

(54) Hydraulic clutch transmission element for a hybrid traction chain of a motor vechicle, and motor vehicle comprising one such element

(75) Inventors: Emmanuel Combes, Saint-Cyr-sous-Dourdan (FR); Jerome Victor, Suresnes (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/570,020

(22) PCT Filed: Jun. 1, 2005
(86) PCT No.: PCT/FR05/50400

§ 371 Date: Dec. 4, 2006

(30) Foreign Application Priority Data
Jun. 3, 2004 (FR) 0406024

(51) Int. Cl. F16D 19/00; F16D 25/00

(52) U.S. Cl. 192/87.11

(57) ABSTRACT

The invention relates to an element comprising an input shaft (37), an output shaft (39), an electric motor (31) comprising a stator (61) and a rotor (63), a first clutch (33) connecting the input shaft (37) and the rotor (63), and a second clutch (35) connecting the rotor (63) and the output shaft (39), said clutches (33, 35) being hydraulic clutches. The transmission element (25) is provided with means for controlling the clutches (33, 35), said means comprising a control fluid circuit (302) and means for bringing (115, 116) at least one of said clutches (33, 35) back into the closed position. The invention also relates to a motor vehicle comprising one such transmission element.

The invention concerns a transmission element for a traction chain of the parallel hybrid type, said element comprising a movement input shaft intended to be connected to a thermal engine, a movement output shaft intended to be connected to a gear box, an electrical machine comprising a stator and a rotor, a first connecting clutch between the input shaft and the rotor, and a second connecting clutch between the rotor and the output shaft, said clutches being of the wet type, said transmission element further comprising a circuit of lubrication and/or cooling fluid, and control means of said clutches, which comprise a circuit of control fluid, in particular a hydraulic control circuit, the control circuit comprising a pressure chamber for each clutch, such that the pressure of control fluid which prevails in a pressure chamber determines the state of the respective clutch.

By parallel hybrid traction chain, it is meant a traction chain providing to a wheel shaft a mechanical energy from at least one engine of the “irreversible” type (in general, a thermal engine) and at least one engine of the “reversible” type (in general, an electrical machine, which will be designated in the following by the term “the electric motor,” it being understood that this “motor” can operate according to a motor mode and a generator mode), and in which the energy node coming from these two engines has a mechanical nature.

French patent application FR 2 814 121 describes a transmission element of the above type, in which the clutches are open, i.e., in unclutched, or sliding, position, in the absence of the application of a control pressure.

It is observed that, over the cumulated life of the operating vehicle, at least one of the clutches is more often closed than open. Consequently, the control circuit of this clutch, and more generally of the two clutches, consumes energy, for the circulation and the pressurization of control fluid, much higher than the energy useful to provide the control.

An objective of the invention is to remedy this drawback, and to propose a transmission element of the above type, whose energy consumption dedicated to clutch control is minimized.

To this effect, in a transmission element conform to the invention, said control means comprise return means of at least one of said clutches to the closed position, the pressure of control fluid in the associated pressure chamber acting on said clutch toward its open position.

Thanks to this arrangement, the design of the source of pressure of control fluid can be modified so as to minimize the operating energy, the service hardship, and the dimensions. Further, the duration of the pressurization of the control piston on the clutch discs is reduced.

According to other characteristics of the invention, taken alone or according to all combinations that can be envisioned technically:
said control means comprise return means of the two clutches to closed position;
the control fluid is identical to the lubrication and/or cooling fluid;
the control circuit is partially common with the lubrication and/or cooling circuit;
the control circuit comprises a source of pressure, and for each clutch, an electrovalve connecting the respective pressure chamber to said source of pressure, said electrovalve being capable of taking selectively a plurality of positions among a rest position, in which the pressure chamber is connected to a discharge circuit, and active positions, in which pressurized control fluid can circulate from the source of pressure toward the pressure chamber;
the source of pressure comprises a pressure generator, a pressure accumulator, an emission conduit of control fluid, connected, on the one hand, to said pressure generator, and on the other hand, to said pressure accumulator, and an electrovalve disposed between the pressure accumulator and the emission conduit, said electrovalve being adapted to open or close selectively the link between the accumulator and the emission conduit, so that the accumulator operates selectively according to:
a receptor mode in which it is charged by the pressure generator;
an emitter mode in which it dispenses control fluid into the emission conduit; and
a neutral mode in which it is isolated from the emission conduit;
the generator comprises a high pressure pump, a tank of control fluid, a check valve, said pump being connected, upstream, to the tank, and downstream, to the emission conduit via the check valve;
the transmission element comprises a emission pressure sensor adapted to measure the pressure prevailing in the emission conduit, and the pump comprises a motor and a control unit of said motor, which is connected to said emission pressure sensor and which drives the motor as a function of pressure value measured by said sensor;
the control circuit comprises a security valve connected to the emission conduit and adapted to set in communication said emission conduit with a discharge circuit if the pressure in the emission conduit is higher than a predetermined threshold value;
each pressure chamber is associated to a chamber pressure sensor adapted to measure the pressure prevailing in the respective chamber, and said transmission element comprises a control unit connected to said chamber pressure sensors and adapted to drives said electrovalves as a function of the pressure values measured by said chamber pressure sensors; and
the lubrication and/or cooling circuit comprises a low pressure pump and a tank of lubrication and/or cooling fluid, connected to the pump upstream of the latter.

Another objective of the invention is a motor vehicle comprising a traction chain of the parallel hybrid type, said traction chain comprising a thermal engine, a gear box, and a transmission element such as described above, connecting the thermal engine to the gear box.

A particular embodiment of the invention will now be described in more details in reference to the annexed drawings, in which:

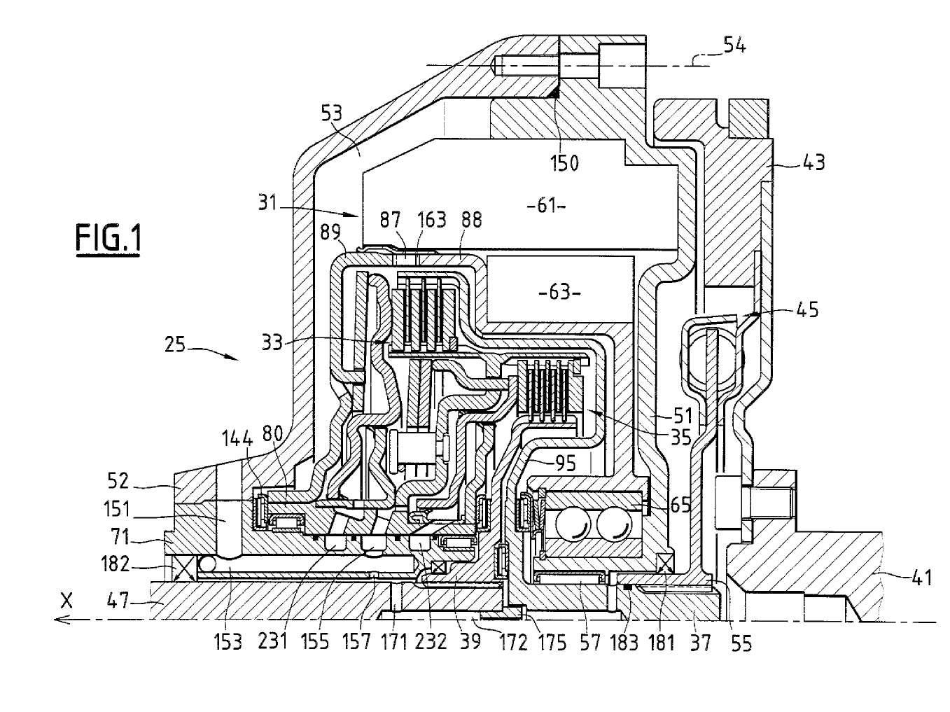

FIG. 1 is a partial view in partial axial cross-section of a transmission element according to the invention;

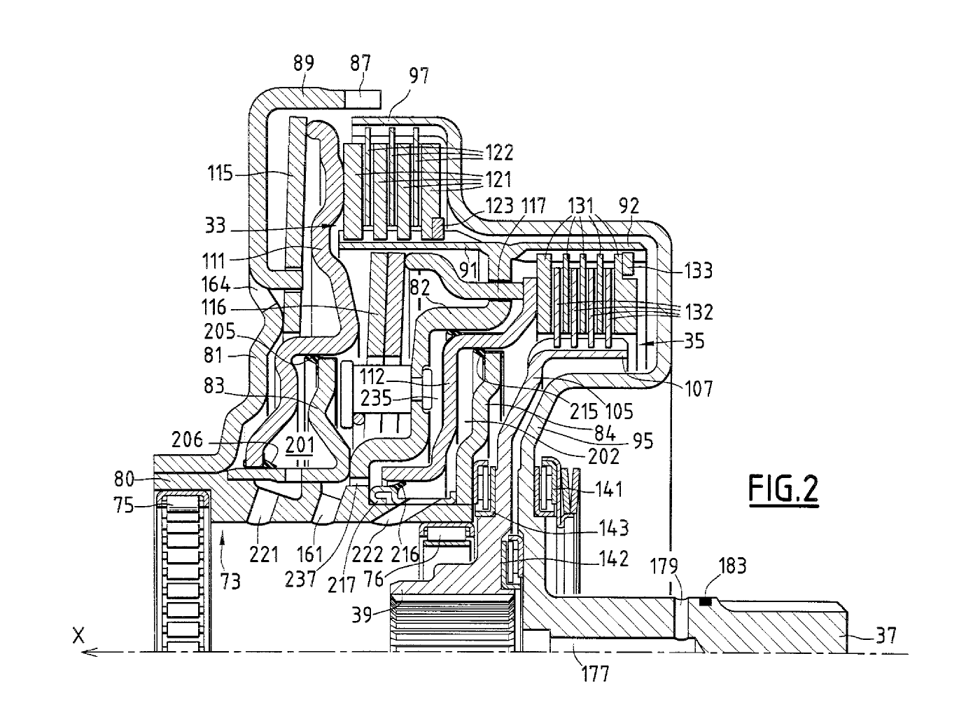

FIG. 2 is a view of a detail of FIG. 1, at a larger scale, which shows a module of the transmission element, comprising essentially the clutches, the input and output shafts, the intermediate member, and the pistons; and

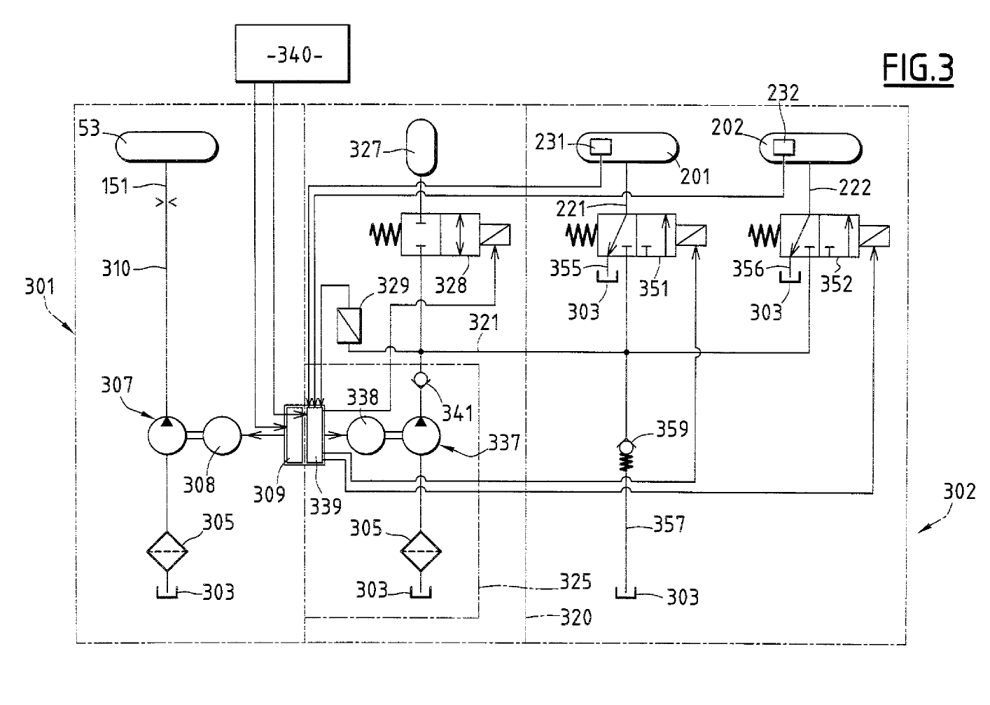

FIG. 3 is a flow chart of the hydraulic control circuit, and of the hydraulic cooling and lubrication circuit of the transmission element of FIGS. 1 and 2.

FIGS. 1 and 2 show a transmission element 25 conform to the invention, intended to connect a thermal engine to a gear box. The element 25 of the invention comprises an electrical machine 31, which will be called “electric motor,” a first clutch 33, and a second clutch 35.

The transmission element 25 comprises further coaxial movement input shaft 37 and movement output shaft 39 having an axis X. The axis X is oriented from the input toward the output to facilitate the following description.

The terms “upstream” and “downstream” have a meaning in reference to this orientation.

The input shaft 37 is integral in rotation with the crankshaft of the thermal engine, of which a portion, or “nose,” is shown on FIG. 1 under reference numeral 41.

In the example shown, the crankshaft 41 is equipped with a flywheel 43, and connected to the input shaft 37 via a damping device 45.

The output shaft 39 is linked in rotation to the primary gear box input shaft, of which a portion is shown on FIG. 1 under reference numeral 47.

The transmission element 25 comprises a casing constituted essentially by a first half-shell 51 and a second half-shell 52, assembled by fixation means distributed over the periphery of the casing and symbolized on FIG. 1 by interrupted lines 54. The casing half-shells 51, 52 delimitate internally a housing 53, inside which are arranged the electric motor 31, the clutches 33, 35, and the input 37 and output 39 shafts, in a coaxial manner.

The input shaft 37 and the output shaft 39 are mounted movable in a rotation with respect to the casing 51, 52.

The input shaft 37 is a fluted shaft complementary to a hollow shaft 55 of the damping device 45, and an end portion of the input shaft 37 protrudes axially from the first half-shell 51. The input shaft 37 is mounted movable in rotation on the first half-shell 51 via a rolling bearing 57.

The output shaft 39 is a hollow shaft with internal flutes, having a shape complementary to the end of the gear box input shaft 47. To be engaged with the output shaft 39, the end of the gear box input shaft 47 protrudes inside the housing 53.

The electric motor 31 comprises a stator 61, equipped with a collector, integral with the first casing half-shell 51, and a rotor 63 mounted movable in rotation on the first half-shell 51 via a bearing 65. The rotor 63 is arranged radially inside the stator 61.

The first 33 and second 35 clutches are of the wet type, and the transmission element 25 is equipped with an axial tube 71 for distribution of lubrication and cooling fluid as well as for control. This tube 71 protrudes inside the housing 53 of the second casing half-shell 52.

The transmission element 25 has an intermediate transmission member 73 mounted movable in rotation on the tube 71, radially outside, via two bearings 75, 76.

The intermediate member 73 is formed essentially with a hub 80, and four radial walls 81, 82, 83, 84, shifted axially with respect to each other, and made integral with the hub 80 by welding for walls 81, 82, 84, and by hooping for wall 83.

The intermediate member 73 is linked in rotation with the rotor 63 via complementary axial teeth 87 which are mutually engaged, and formed on a peripheral portion of the rotor 63 and on a peripheral portion of the first radial wall 81, respectively.

The second radial wall 82 is formed with an integral peripheral ring constituted by a first half-ring 91 extending in the downstream axial direction, and a second half-ring 92 extending in the upstream axial direction.

Correspondingly, the input shaft 37 is formed, preferably in one piece, with a radial wall 95 which extends inside the housing 53, and which has at its periphery an axial ring 97. The axial ring 97 extends in a coaxial and radially external manner, with respect to the downstream half-ring 91. The first clutch 33 is arranged between said half-ring 91 and said ring 97.

In the same manner, the output shaft 39 is formed, preferably in one piece, with a radial wall 105 which extends inside the housing 53, and which has at its periphery an axial ring 107. The axial ring 107 extends in a coaxial and radially external manner, with respect to the upstream half-ring 92 of the intermediate member 73. The second clutch 35 is arranged between said half-ring 92 and said axial ring 107.

The transmission element 25 comprises further a first actuating piston 111 and a second actuating piston 112 of the first clutch 33 and of the second clutch 35, respectively, as well as a first spring member 115 and a second spring member 116 acting on the first piston 111 and on the second piston 112, respectively, toward pressing on the respective clutch 33, 35.

Between the piston 112 and the spring member 116 is interposed, supported axially, a spacer having essentially axial fingers 117 distributed on the periphery of a ring. These fingers 117 pass through the wall 82.

The first clutch 33 is essentially constituted by a first series of discs 121 linked in rotation to the first half-ring 91 by flutes, and movable axially on the latter, along these flutes, under the action of piston 111; and of a second series of discs 122 linked in rotation to the axial ring 97 by flutes, and movable axially on the latter, along these flutes also under the effect of piston 111. The first discs 121 and the second discs 122 are interleaved with each other in an alternating manner.

The discs 121, 122 are stopped axially by a stop 123 opposed to the piston 111.

It is observed that the discs 121, 122 can pass from an unclutched position, in which the first discs 121 are not in contact with the second discs 122, and an engaged position of the first discs 121 and second discs 122, in which the first discs 121 and second discs 122 are pressed against each other.

In the unclutched position, the input shaft 37 and the intermediate member 73 are free in rotation with respect to each other.

The first spring member 115, constituted in the example shown by a spring-washer, for example, of the Belleville washer type, is fixed to the first radial wall 81, and acts on the piston 111 in the engaged position.

The second clutch 35 has a constitution and operation analogous to the first: it comprises a first series of discs 131 associated to the second half-ring 92, and a second series of interleaved discs 132, associated to the axial ring 107. The axial movement of the discs 131, 132 is limited by a stop 133.

In the example shown, the spring member 116 is a double spring washer, of the Belleville type, fixed to the second wall 82. The spring member 116 acts on the piston 112 toward the engaged position of the second clutch 35, via fingers 117.

As is visible on FIG. 1, the two clutches 33, 35 are shifted axially and radially according to a tiered or “stepped” arrangement, i.e., the first clutch 33 is disposed radially outside with respect to the second clutch 35. The latter is arranged inside the rotor 63.

The transmission element 25 is further equipped with needle stops, among which a first one 141 is interposed axially between the bearing 65 and the radial wall 95 of the input shaft 37; a second one 142 is interposed axially between the radial wall 95 and the radial wall 105 of the output shaft 39; a third one 143 is interposed between the radial wall 105 and the radial wall 84 of the intermediate member 73; and a fourth one 144 is interposed between the hub 80 and a shoulder of the tube 71.

The fluid distribution tube 71 is adapted to distribute lubrication and cooling fluid inside the transmission element 25, i.e., inside the housing 53. The latter is sealed with respect to this fluid, in particular in the area of the jointing of the two casing half-shells 51, 52, by means of a peripheral seal 150.

In the vicinity of the axis X, the sealing of the transmission element 25 against the lubrication and cooling fluid is obtained, on the one hand, by a first lip seal 181, which is supported on the first half-shell 51 and the outside surface of the hollow shaft 55, and by a second lip seal 182, which is supported on the inside surface of the tube 71 and on the outside surfaces of the primary gear box input shaft 47, and on the other hand, by an O-ring 183 placed between the input shaft 37 and the hollow shaft 55.

This tube 71 has, provided in its wall, a first fluid supply radial channel 151, a first distribution axial channel 153 connected to said supply channel 151, an orifice 155 provided between the distribution channel 153 and the outside of the tube 71, and an orifice 157 provided between the distribution channel 153 and the inside of the tube.

The hub 80 of the intermediate member 73 is equipped with a channel 161 opening onto the orifice 155, and setting in communication the distribution channel 153 and the housing 53.

In operation, the supply channel 151 is connected to a circuit, which will be described below, for the supply of cooling and lubrication fluid. This fluid is diffused inside the housing 53 via the distribution channel 153, the orifice 155, and the channel 161, so as to lubricate and cool the first clutch 33, the second clutch 35, and the electric motor 31.

It will be noted that the lubrication and cooling fluid is diffused radially toward the stator 61, thanks in particular to the passage 163 provided in the area of the teeth 87. The dimensioning of this passage 163 makes it possible to control the fluid flow rate organized between the portion of the housing 53 internal to the rotor 63, and the external portion in which the stator 61 is arranged.

It will also be noted that the relative disposition of the clutches 33, 35, and of the electric motor 31 makes it possible, due to the centrifugation of the lubrication and cooling fluid, to keep the first clutch 33 in a bath of lubrication and cooling fluid, during operation of the transmission element 25, whereas the area of the second clutch 35 is the seat of a mist of this same fluid. The interest of this disposition is to adapt the amount of fluid, present in the area of each clutch, in particular the calorific energy generated by these clutches.

The bath of fluid, in general, oil, in which the clutch 33 is maintained, is leveled thanks to a passage 164 in the area of the radial wall 81.

The first clutch 33 being subjected to heating more importantly than the second clutch 35, it is indeed necessary to organize, in the vicinity of first clutch, a markedly higher flow rate of cooling fluid.

The more important heating of the clutch 33, as compared to the clutch 35, is due to slipping phases, which are more constraining for the first than for the second. Further, maintaining the clutch 35 in a mist of fluid, rather than in a bath, makes it possible to reduce the drag forces of this fluid on the primary gear box shaft.

Further, the cooling and lubrication fluid is distributed toward the rolling bearing 57 and the bearing 65 to cool and lubricate the latter, via, successively: the distribution channel 153; the orifice 157; a radial passage 171 formed in the primary gear box input shaft 47; an axial channel 172 provided in this shaft; a nozzle 175 making it possible to adjust the fluid flow rate; an axial channel 177 formed in the input shaft 37; and, finally, a radial passage 179 opening in the vicinity of the rolling bearing 57.

The fluid distributed along this path flows into the housing 53, through the rolling bearing 57, toward the bearing 65 and the rotor 63, then toward the stator 61. The stator 61 and the rotor 63 are thus cooled and lubricated, not only by fluid which has transited via the orifice 155 and the passages 163, 164, but also by fluid which has transited via the orifice 157 and the path detailed previously. This fluid also makes it possible to lubricate the stops 141, 142, 143.

The dispositions that make it possible to move the pressure pistons or plates 111, 112, and thus to move the clutches 33, 35 from a position to another among their engaged and unclutched positions, will now be described.

The first piston 111 defines, with the third radial wall 83 and the outside surface of the hub 80, a first pressure chamber 201, while the second piston 112 defines, with the fourth radial wall 84 and the outside surface of the hub 80, a second pressure chamber 202.

The first pressure chamber 201 is substantially sealed with respect to a control fluid by means of a lip seal 205 fixed in the periphery of the radial wall 83, and applied on a surface of the piston 111, and of a lip seal 206 fixed on a radially internal edge of the piston 111, and applied on the outside surface of the hub 80.

In an analogous manner, the pressure chamber 202 is substantially sealed by a first seal 215 applied on the radial wall 84 and the piston 112, and by a second lip seal 216 applied on the piston 112 and the outside surface of a part 217 arranged on the hub 80.

Each pressure chamber 201, 202 opens into the central bore of the hub 80 via two channels 221, 222, respectively, for the passage of the control fluid supply, formed in the hub 80.

The fluid distribution tube 71 is itself equipped with two channels 231, 232, connected to a control fluid supply circuit via respective radial supply channels (not shown) analogous to the channel 151, and respective axial distribution channels (not shown) analogous to the channel 153. The channels 231, 232, communicate with the passages 221, 222, respectively.

In the example shown, the control fluid is the same as the lubrication/cooling fluid, the control and lubrication/cooling circuits being partially common.

It is observed that, from an initially closed position of the clutch 33, 35, the passage to the unclutched position is obtained by supplying the respective pressure chamber 201, 202 with pressurized control fluid. The corresponding piston 111, 112 is then moved axially in the downstream direction, according to the orientation of the axis X (toward the left on FIG. 2), while compressing the spring member 115, 116 and releasing the piles of discs 121, 122, 131, 132.

Under the action of the spring 115, 116, the piston 111, 112 goes back to its initial position when the pressure of the control fluid in the respective pressure chamber 201, 202 is brought back to its low initial value. The clutch 33, 35 goes back then to its so-called “naturally closed,” i.e., engaged, position, in the absence of a supply of the pressure chamber 201, 202 with control fluid.

It is observed that the two clutches 33, 35 can be operated independently, and that the description above relative to the operation of the clutches 33, 35 applies to one or the other independently.

Further, the pressure of control fluid which can be delivered to the pressure chambers 201, 202 can vary over a range of values, such that the corresponding clutch 33, 35 can be brought in one among zero (unclutched), total (engaged), or partial (sliding) transmission states.

It must be observed that the second radial wall 82 and the piston 112 define between them a compensation chamber 235, located on the side opposite the second pressure chamber 202 with respect to the piston 112. This compensation chamber 235 is supplied with lubrication and cooling fluid via the channel 161 and an orifice 237 provided in the radial wall 82. Thus, at high engine speed, the additional forces generated on the piston 112 by the centrifugation of the control fluid contained in the second pressure chamber 202 are compensated, and the piston 112 operates so as to allow the passage, between the discs 131, 132, of the torque for which it has been dimensioned. It can also be noted that the dimensioning of the clutch 33, of the piston 111, and of the spring 115, makes it possible to avoid a compensation chamber for the control of this clutch 33.

In reference to FIG. 3, the hydraulic control circuit of the clutches 33, 35, and the hydraulic cooling and lubrication circuit of the transmission element 25, will now be described.

The cooling and lubrication circuit 301 comprises:
a tank 303 of cooling and lubrication fluid, such as oil,
a filtration element (or strainer) 305 placed at the output of said tank,
a low pressure pump 307 equipped with a motor 308 and a control unit 309 of said motor, and
a lubrication conduit 310 connecting the pump 307 to the housing 53 of the transmission element 25, via the supply channel 151, and the fluid distribution tube 71. The control circuit 302 comprises a source of pressure 320, equipped with an output conduit 321 constituting an emission conduit of control fluid toward the pressure chambers 201, 202 of the clutches 33, 35.

The source of pressure 320 comprises a pressure generator 325, a pressure accumulator 327, an electrovalve 328 connecting the pressure accumulator 327 to the emission conduit 321, and an emission pressure sensor 329, which measures the control fluid pressure prevailing in the emission conduit 321.

Each pressure chamber 201, 202 is equipped internally with a respective sensor 231, 232 measuring the pressure prevailing at each instant in the chamber. Alternatively, the information on pressure in the chambers 201, 202 could be obtained by sensors placed in the channels 221, 222.

In the example shown, the control fluid is identical to the lubrication and cooling fluid, and the control circuit is partially common with the lubrication and cooling circuit.

Thus, the pressure generator 325 comprises
a control fluid tank constituted by the tank 303,
a filtration element (or strainer) placed at the output of the tank, and constituted by the filter 305,
a high pressure pump 337, equipped with a motor 338 and a control unit 339 of said motor.

In the example shown, the control unit 339 of the motor of the high pressure pump and the control unit 309 of the motor of the low pressure pump are physically united into a same central control member.

The control units 309, 339 are connected to a supervision unit 340 that manages the operation of the traction chain. The supervision unit 340 receives information on the state or the operation of parts of the vehicle, and emits in turn respective information signals to the control units 309, 339.

The pressure generator 325 comprises further a check valve 341, via which the high pressure pump 337 is connected to the emission conduit 321, so that the control fluid can circulate only from the pump 337 to the emission conduit 321.

The electrovalve 328 is capable of taking two positions:
in the first position, a rest position, corresponding to a neutral operation mode of the accumulator 327, the latter is isolated from the emission conduit 321 (position shown on FIG. 3), and
in the second position, an active position, the accumulator 327 communicates with the emission conduit 321, the control fluid being able to flow in one direction or the other. The accumulator operates then according to a fluid receptor or emitter mode.

The emission conduit 321 is connected to each of the channels 221, 222 for passage of control fluid, opening into the respective pressure chambers 201, 202, via respective proportional electrovalves 351, 352 having two extreme positions.

Each of these electrovalves 351, 352 of the control circuit 302 can take selectively a position among an extreme rest position (shown on FIG. 3), an extreme active position, and intermediary active positions.

In the rest position, the pressure chamber 201, 202 is set in communication with a discharge circuit 355, 356, which may open, for example, into the tank 303, and isolated from the emission conduit 321.

In the active positions, the pressure chamber 201, 202 is set in communication with the emission conduit 321 so as to be able to be supplied in control fluid, while the discharge circuit 355, 356 is closed in the area of the electrovalve 351, 352.

The control circuit 302 comprises further another discharge circuit 357 connected to the emission conduit 321 via a security valve 359, intended so as to open and set the emission conduit 321 in communication with the discharge circuit 357, when the pressure in the emission conduit is higher than a predetermined threshold value. The discharge circuit 357 can be connected to the tank 303 of control fluid, so as to recycle the excess fluid in the emission conduit 321.

The control unit 309 drives the motor 308 as a function of some of the information signals, and optionally of lubrication and/or cooling instruction signals, coming from the supervision unit 340.

The control unit 339 is connected further to the sensors 231, 232, 329, from which it receives the pressure information.

In other embodiments, one or several of these pressure sensors 231, 232, 329 are not used in the elaboration of the control and can thus be eliminated.

The control unit 339 drives the motor 338 as a function, in particular, of the pressure information of the sensor 329 and of some of the information signals of the supervision unit 340.

In practice, the control unit 339 drives, not only the motor 338, but also the electrovalve 328, and optionally the electrovalves 351, 352, in a synchronized manner, in particular as a function of the pressure information of the sensors 231, 232, and of some of the information signals of the supervision unit 340.

For example, the control unit 339 can drive the motor 338 so as to supply control fluid into the emission conduit 321, with a view at recharging the pressure accumulator 327, when the electrovalve 328 is in the second position.

The operation of the control circuit 302 will now be described more particularly.

The clutches 33, 35 are assumed to be, in the initial state, in their engaged (or closed) positions, the pressure prevailing in the pressure chambers 201, 202 being at a low value P₀.

The pressure accumulator 327 must, at each instant, be charged so as to be able to supply with a very short response time, into the pressure chambers 201, 202, a fluid pressure called “high pressure,” P₁, sufficient to move the pistons 111, 112 until the clutches 33, 35 are brought into their unclutched (or closed) configuration. If this is not the case, the control unit 339 actuates the pump motor 338, and the electrovalve 328 is moved into its active position, so that the pressure accumulator 327 is recharged.

When one of the clutches 33, 35 must be brought into a sliding position, or into the completely unclutched position, the corresponding electrovalve 351, 352 is moved into an adapted active position. Simultaneously, the electrovalve 328 is also moved into an active position. The check valve 341 preventing the fluid contained in the emission conduit 321 from returning toward the generator 325, the fluid coming from the accumulator 327 is introduced into the pressure chamber 201, 202, in which the pressure reaches quasi-instantaneously the target value. At this target value is associated a position of the respective proportional valve 351 or 352.

In particular, the pressure in one and/or the other of the two chambers can reach quasi-instantaneously the high value P₁, which constitutes the declutch control value.

Of course, the two clutches 33, 35 can be actuated in an independent manner.

It is observed also that, if both clutches 33, 35 must be brought into unclutched positions at the same time, both electrovalves 351, 352 are operated as indicated above.

As an example, the invention can be embodied with the following characteristics:
the electric motor 31 has a mechanical power of 16 kW;
the two clutches 33, 35 are intended to be capable of transmitting each a torque of 270 N·m;
the low pressure pump 307 provides a fluid at the maximal pressure of 2 bar, with a maximal flow rate of 6 l/min.;
the high pressure pump 337 provides a fluid at the maximal pressure of 55 bar, with a maximal flow rate of 0.9 l/min.;
the accumulator 327 has a volume of 84 cm³;
the electrovalves 351, 352 have an operating range from 0 to 15 bar;
the security valve is scaled at 60 bar; and
the capacity of the common tank 303 is selected to be equal to about 2 liters.

In another embodiment, it is provided that the control circuit 302 and the lubrication and cooling circuit 301 use different fluids. The tanks 303 of the two circuits are then constituted by distinct tanks, the two circuits being then essentially distinct.

1. Transmission element for a traction chain of the parallel hybrid type, said element comprising a movement input shaft intended to be connected to a thermal engine, a movement output shaft intended to be connected to a gear box, an electrical machine comprising a stator and a rotor, a first connecting clutch between the input shaft and the rotor, and a second connecting clutch between the rotor and the output shaft, said clutches being of the wet type, said transmission element further comprising a circuit of lubrication and/or cooling fluid, and control means of said clutches, which comprise a circuit of control fluid, in particular a hydraulic control circuit, the control circuit comprising a pressure chamber for each clutch, such that the pressure of control fluid which prevails in a pressure chamber determines the state of the respective clutch wherein said control means comprise return means of at least one of said clutches to the closed position, the pressure of control fluid in the associated pressure chamber acting on said clutch toward its open position.

2. Transmission element according to claim 1, wherein said control means comprise return means of the two clutches to closed position.

3. Transmission element according to claim 1, wherein the control fluid is identical to the lubrication and/or cooling fluid.

4. Transmission element according to claim 3, wherein the control circuit is partially common with the lubrication and/or cooling circuit.

5. Transmission element according to claim 1, wherein the control circuit comprises a source of pressure, and for each clutch, an electrovalve connecting the respective pressure chamber to said source of pressure, said electrovalve being capable of taking selectively a plurality of positions among a rest position, in which the pressure chamber is connected to a discharge circuit, and active positions, in which pressurized control fluid can circulate from the source of pressure toward the pressure chamber.

6. Transmission element according to claim 5, wherein the source of pressure comprises a pressure generator, a pressure accumulator, an emission conduit of control fluid, connected, on the one hand, to said pressure generator, and on the other hand, to said pressure accumulator, and an electrovalve disposed between the pressure accumulator and the emission conduit, said electrovalve being adapted to open or close selectively the link between the accumulator and the emission conduit, so that the accumulator operates selectively according to:
a receptor mode in which it is charged by the pressure generator;
an emitter mode in which it dispenses control fluid into the emission conduit; and
a neutral mode in which it is isolated from the emission conduit.

7. Transmission element according to claim 6, wherein the generator comprises a high pressure pump, a tank of control fluid, a check valve, said pump being connected, upstream, to the tank, and downstream, to the emission conduit via the check valve.

8. Transmission element according to claim 7, which comprises a emission pressure sensor adapted to measure the pressure prevailing in the emission conduit, and the pump comprises a motor and a control unit of said motor, which is connected to said emission pressure sensor and which drives the motor as a function of pressure value measured by said sensor.

9. Transmission element according to claim 6, wherein the control circuit comprises a security valve connected to the emission conduit and adapted to set in communication said emission conduit with a discharge circuit if the pressure in the emission conduit is higher than a predetermined threshold value.

10. Transmission element according to claim 5, wherein each pressure chamber is associated to a chamber pressure sensor adapted to measure the pressure prevailing in the respective chamber, and in that said transmission element comprises a control unit connected to said chamber pressure sensors and adapted to drive said electrovalves as a function of the pressure values measured by said chamber pressure sensors.

11. Transmission element according to claim 1, wherein the lubrication and/or cooling circuit comprises a low pressure pump and a tank of lubrication and/or cooling fluid, connected to the pump upstream of the latter.

12. Motor vehicle comprising a traction chain of the parallel hybrid type, said traction chain comprising a thermal engine, a gear box, and a transmission element according to claim 1 connecting the thermal engine to the gear box.
